(19) United States
(12) Patent Application Publication
(10) Pub. No.: US 2001/0042088 A1
(43) Pub. Date: Nov. 15, 2001

(54) SYSTEM IMPLEMENTING ELECTRONIC REVIEW AND APPROVAL OF APPLICATIONS TO PERFORM NONSTANDARD MEDICAL OR VETERINARY PROCEDURES

(76) Inventors: ROBERT N. HOTCHKISS, RIVERSIDE, CT (US); TIMOTHY WRIGHT, STAMFORD, CT (US)

Correspondence Address: GENE S WINTER, ST ONGE STEWARD JOHNSTON & REENS LLC, 986 BEDFORD STREET, STAMFORD, CT, 069055619

(21) Appl. No.: 09/374,281

(22) Filed: Aug. 13, 1999

Related U.S. Application Data
(63) Continuation-in-part of application No. 09/299,172, filed on Apr. 26, 1999.

(51) Int. Cl. G06F 15/00

(52) U.S. Cl. 707/530

(57) ABSTRACT

The invention provides a medical or veterinary procedure review system comprising an application to perform a nonstandard procedure on a patient, a computer for receiving the application, a program to forward the application to a reviewer, storage of a review together with the application, and a record of the review process for consideration by a third party. In another aspect the invention provides a system for auditing the application review process to assume compliance with established guidelines.

This application is a continuation-in-part of co-pending U.S. patent application Ser. No. 09/299,712 filed Apr. 26,1999.

### FIELD OF THE INVENTION

The invention relates to a system for electronically conducting and managing the review process for approving performance of nonstandard medical or veterinary procedures, for generating consent forms to be obtained before such procedures are performed, and for auditing the review and approval process to assure compliance with government and/or insurance regulations and requirements.

### BACKGROUND OF THE INVENTION

Investigators and medical professionals often wish to perform nonstandard medical or veterinary procedures in order to advance the state of the art in care and to meet the treatment demands of patients. Because such procedures are experimental by definition, institutions (such as hospitals, clinics, corporations, nonprofits such as the Red Cross, organizations such as the NIH, and other government agencies) understandably wish to exert some measure of control over their use on individuals and other research subjects under their care.

Institutional review and approval of applications to perform nonstandard medical or veterinary procedures, and obtaining of signed consents before they are performed, is widely known and used by hospitals and clinics. This review and approval process provides institutions with a means to comply with insurance and governmental requirements as well as their own policies on performing nonstandard procedures. Institutional Review Boards (IRB) perform this function in hospitals for human patients and Institutional Animal Care and Use Committees (IACUC) perform this function in clinics for animal patients.

One difficulty is that if government or foundation sponsored research is being performed by the institution, the government or foundation may have requirements about how any applications to perform nonstandard procedures must be reviewed in order for the institution to qualify for funding. Failure to follow such government guidelines may result in interruption or revocation of government funding. Obviously such an event could have a serious detrimental impact on an institution's operations.

In some cases, if the government suspects noncompliance it may audit an institution's application review procedures for compliance. Surviving such an audit often requires an institution to demonstrate compliance with the requirements for one or more applications to perform nonstandard procedures reviewed by the institution. This means that IRBs, IACUCs and other less formal review committees must generate and archive large volumes of paper such as committee meeting minutes, reviewer comments, final committee votes, and the like to document how each application to perform a nonstandard procedure has been reviewed. The burden of this paperwork is exacerbated by the fact that access to the records may have to be carefully controlled even among members of the same review committee in order to facilitate impartiality of the committee members.

The guidelines to be followed by review committees may include things such as a thorough risk/benefit analysis with respect to the patient and careful consideration of the severity and probability of complications and other possible adverse events by a group of uninterested experts in the field, lay people and/or ethicists, together with the content of an appropriately informed consent.

Even if institutions follow the correct review and approval process, they may run afoul of requirements on the scope of permission they grant to perform the procedure. Guidelines may specify a conditional or other limited approval to perform the nonstandard procedure, and the institution in an audit process, may be required to demonstrate the steps it follows to be sure the conditions and limitations of its approvals are followed in practice

This review process is also important to the reputation, professionalism and reliability of the institution's care, such that the institution itself has strong incentives to follow guidelines of its own for controlling the quality of care offered by its medical and veterinary professionals, permitting nonstandard procedures where appropriate to advance the science while preventing them where not appropriate to safeguard the patient. Institution's liability insurance carriers may also want to be sure the proper permissions and an informed consent have been obtained before any nonstandard procedure is performed by the institution

In addition to the necessity to generate a paper trail of the approval process for audit purposes, the review and approval process often must be completed on an expedited basis due to medical exigencies. This of course increases the burden of generating and retaining an audit trail and may be difficult to accomplish when the review committee meets in person or by teleconference as is common.

Several sources of delay exist in the review and approval process. Committee members are by definition leaders in their chosen field and not only have many demands for their time and attention, but also are typically engaged in their own very critical medical procedures. One reason for delay is simply a lack of time, especially for a joint face-to-face meeting. Less formal meeting practices place yet additional burdens on the ability to generate an audit trail of the process. Members may also have a large number of proposed procedures to review. Delays may also be caused by the mere fact that reviewers have lost, misplaced or left behind in their office the papers to be reviewed. Management of the committee review process by chairman is therefore equally difficult.

What is desired, therefore, is a system enabling institutional review and approval of nonstandard medical or veterinary procedures which automatically generates an audit trail of the process. A system which tracks compliance with conditional approvals, which generates permissions, and which reduces the time required to complete the review is also desired.

### SUMMARY OF THE INVENTION

It is, accordingly, an object of the invention to provide a system to electronically review and approve applications to perform nonstandard medical or veterinary procedures.

Another object of the invention is to provide a system of the above character in which an audit trail of review process is automatically generated.

A further object of the invention is to provide a system of the above character in which the review and approval process is managed electronically.

Yet another object of the invention is to provide a system of the above character in which an investigator may electronically resubmit an application to perform a nonstandard procedure to correct defects identified in the review process and obtain approval.

Still another object of the invention is to provide a system which requires an investigator to confirm that a required precondition has been met before a consent is generated.

Yet a further object of the invention is to provide a system of the above character in which an auditor or other third party can electronically access and monitor the application review process.

These and other objects of the invention are achieved by provision of a medical or veterinary procedure review system comprising an application to perform a nonstandard procedure on a patient, a computer for receiving the application, a program to forward the application to a reviewer, storage of a review together with the application, and a record of the review process for consideration by a third party.

The third party is preferably either an auditor, an IRB member, an IACUC member, a collaborator, or an equipment manufacturer. The application preferably includes all information necessary to generate a consent form. All committee members may preferably obtain the vote tally, but not who on the committee voted which way

Preferably the system is capable of generating conditional approvals. In cases of a conditional approval, the system preferably also monitors confirmation from an investigator that a condition has been met and then generates a consent form. The condition and confirmation are stored for audit purposes together with the application, review and decision.

In another aspect the invention relates to a system for auditing the application review process to assume compliance with established guidelines.

The invention and its particular features and advantages will become more apparent from the following detailed description considered with reference to the accompanying drawings.

### BRIEF DESCRIPTION OF THE DRAWINGS

FIG. 1 is a block diagram of a system for electronically conducting and managing review and approval of applications to perform nonstandard medical or veterinary procedures in accordance with the invention.

FIG. 2 is a block diagram depicting generation of a consent for an application reviewed in accordance with the system of FIG. 1.

FIG. 3 is a block diagram depicting the chairman's management of application reviews in accordance with the system of FIG. 1.

FIG. 4 is a block diagram depicting the application review process in accordance with the system of FIG. 1

FIG. 5 is a block diagram depicting use of the system of FIG. 1 by a third party.

### DETAILED DESCRIPTION OF THE INVENTION

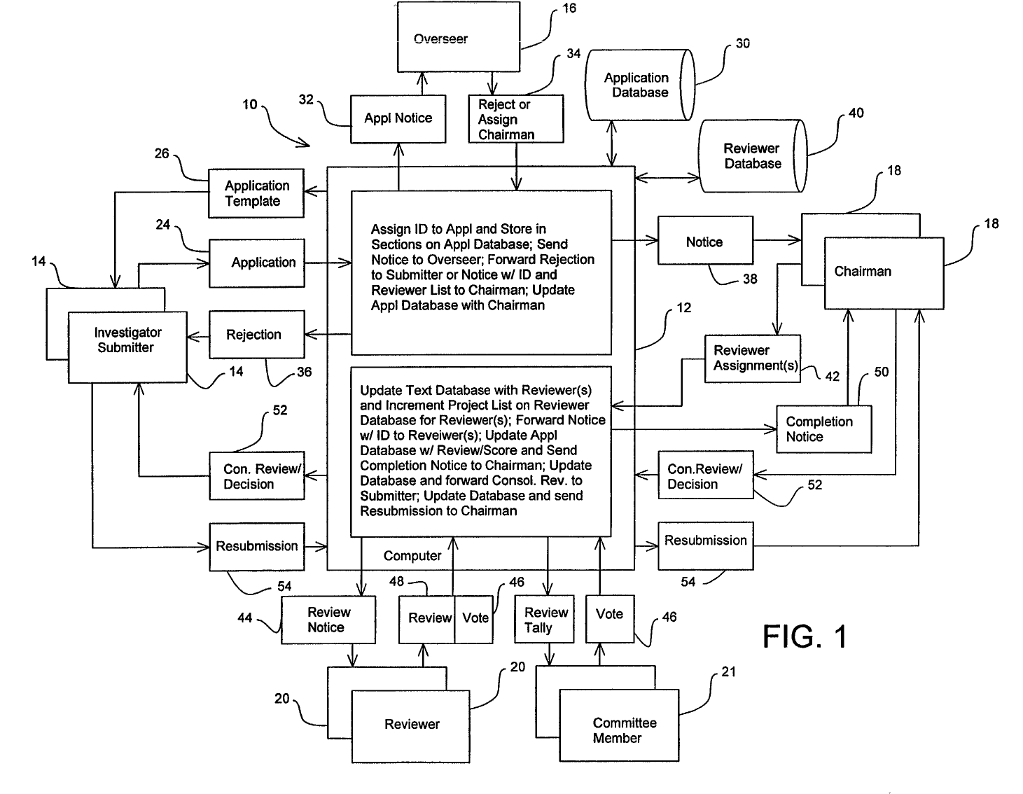

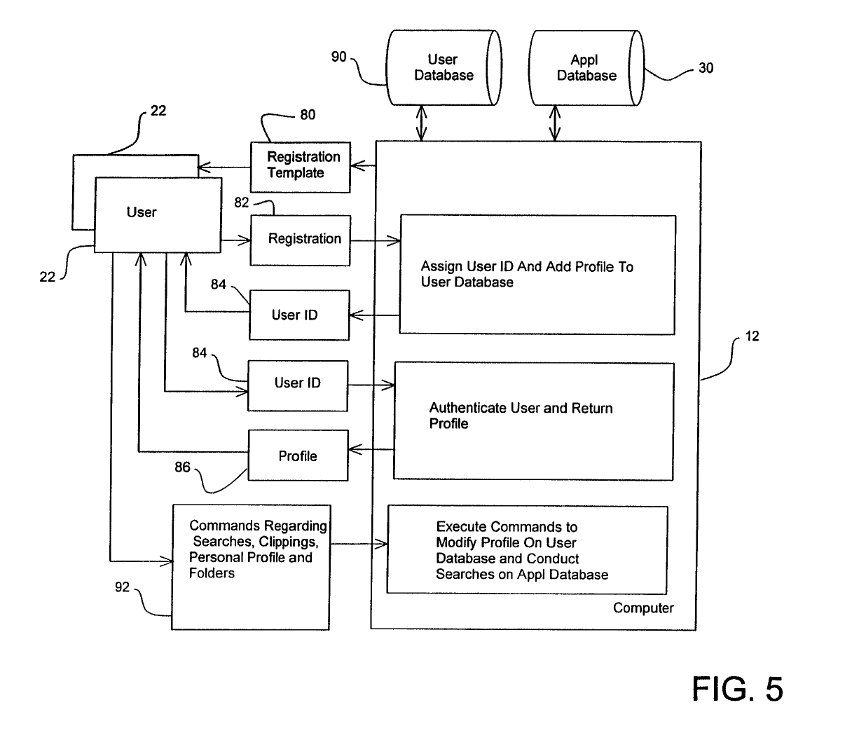

FIG. 1 depicts a system 10 implementing electronic review and approval of applications to perform nonstandard medical or veterinary procedures in accordance with the invention. System 10 comprises a computer 12 and group of parties who interact with the computer, namely: submitters or investigators 14, an institutional overseer 16, review committee chairmen 18, reviewers 20, committee members 21, and third parties 22 (see FIG. 5). It is understood, that each of the parties 14-21 may also be third party users of system 10, and that a chairman, member or reviewer on one committee may be a member, reviewer or chairman on another committee. Further, institutional overseer 16 may, but need not, serve in a dual capacity as an administrator of computer 12. Review committee chairmen 18 serve as managers of review committees such as IRBs and IACUCs. It is the interaction of the parties 14-22 with the computer 12 that forms the basis for the invention. After applications have been reviewed, the system may be used for auditing compliance of the review process with guidelines established by the institution, government, research sponsors or others.

Computer 12 may comprise a single computer, a group of computers such as a server farm, or a network of computers of any type, and parties 14-22 may interact with computer 12 directly via a console, over a LAN or WAN connection, a server and thin client arrangement, or a wired or wireless Internet connection. Preferably, the computer is connected to the Internet and includes web and mail servers for distributing the various notices, applications, reviews and the like. A prototype system was implemented using Lotus® Notes® and Domino® software, however, it is understood that many other programming languages, thin client models and groupware products could also be used without departing from the scope of the invention. In this regard, references made throughout this description to functions performed by computer 12 are actually carried out by software programs executing on computers. “Programs executing on computers” is meant in a broad sense to include firmware and other hardware components which include hard-wired logic.

The review process begins with submission of an application 24 to computer 12 by a submitter/investigator 14. Application 24 is preferably submitted for review in an agreed format, and most preferably is submitted on or in accordance with an application template 26 which is forwarded to a submitter by computer 12 upon request. Template 26 includes a plurality of sections such as abstract, conclusion, method, discussion, results, references, and the like, and may also include category information which is common to all submissions. The application and therefore also the template preferably includes all information necessary to generate a consent form appropriate to perform for the desired procedure if approved. Application 24 is submitted together with a submitter identifier which identifies submitter 14. If submitted, the category information includes subject information which may be used by the institutional overseer 16 to assign a chairman, and/or by the chairman 18 to assign reviewer(s). Typically a single reviewer or small number of reviewers is selected from among members of the designated review committee 21.

Upon receipt of a new application 24, computer 12 assigns the application a unique application identifier and stores the application together with the submitter identifier and application identifier in an application database 30. Preferably, application 24 is stored on database 30 in sections according to template 26. The application and submitter identifiers allow the application and review information pertaining to the application to be quickly and easily retrieved by participants in the review process.

Next, computer 12 forwards an application notice 32 to institutional overseer 16 notifying her that a new application has been received for review. Because applications are published on system 10 electronically, the original application may be appended to include later acquired data in the form of updates, reviews, letters to the committee and the like to present a complete, up to date, record of the application review process in a single, remotely accessible location.

Institutional overseer 16 must first determine whether the submitted application meets the rudimentary standards and policy of system 10 and seeks approval for a procedure which is capable of being performed by the institution. Application notice 32 may forward the application directly to institutional overseer 16 for review, but preferably the notice only provides the institutional overseer with the application identifier for the application so that the institutional overseer can retrieve application 26 from database 30 and review it at her leisure. At 34, the institutional overseer either rejects the application or assigns it to a chairman based upon the subject matter of the application. It is understood that the subject matter of the application may be determined by the institutional overseer or may be retrieved from the category information supplied by the investigator/submitter.

Computer 12, upon receipt of decision 34 either forwards a rejection 36 to the submitter by retrieving the submitter identifier stored together with the application identifier on database 30, or forwards the assigned chairman 18 a notice 38 including the application identifier. Notice 38 also includes a list of individuals 20 retrieved from database 40 who are knowledgeable about the subject matter to which the application pertains and/or who form the review committee. Reviewer database 40 is indexed by expertise of the individual reviewers or by committee, and computer 12 searches database 40 with information about a subject of the application which is either submitted with application 24 or is determined by institutional overseer 16. Generally a single reviewer will accept primary responsibility for commenting on the application, however multiple reviewers may do so if system 10 is so configured or the chairman so desires. The reviewer(s) is typically an anonymous subset of the review committee 21.

Notice 38 may include a copy of the application to be reviewed but preferably only includes the application identifier so that chairman 18 may retrieve application 24 from application database 30 at his leisure. This provides the additional advantage that the application to be edited is retained in a known place on database 30. The database is accessible to chairman 18 as well as any and all of the assigned reviewers from any computer at any location with, e.g., access to the Internet where computer 12 is connected to the Internet. In this regard, loss of, and forgetfulness with respect to the location of, the material to be edited/reviewed is effectively eliminated as a source of delay in the application review process.

Chairman/organizer 18 makes a reviewer assignment 42 based upon matching a subject matter of application 24 with expertise of individual reviewers 20 and/or by selecting an individual member(s) of the review committee as desired or in compliance with guidelines set out to govern the review process. Chairman/organizer 18 may also give consideration to pre-existing review assignment workloads and turn-around rates in determining who to assign to review any new application. The number of assigned reviewers, the size and makeup of the review committee, and the content of the reviews will depend upon the review standards and policy of the institution implementing system 10 and/or any guidelines imposed by insurers, the government, and parties funding research at the institution. It is understood that a single chairman/organizer 16 may be responsible for one or more review committees, and that a single institution may have one or more review committees.

Upon receipt of reviewer assignment(s) 42, computer 12 updates the record on application database 30 with the assigned reviewer(s) to provide them access rights, and increments a project listing for the assigned reviewers on reviewer database 40 to update workload. Computer 12 also forwards a review notice 44 to reviewer(s) 20 which includes the application identifier, enabling the reviewer to retrieve the application at their leisure. The reviewer may either know from the context or may be instructed by the chairman in review notice 44 as to the scope of and due date for their task.

The completed review 48 will include a vote/score or suggested decision on whether to approve the application, and may also include comments on the application, preferably organized by section of the application and possibly providing reasons for a rejection. The suggested decision preferably takes the form: 1) reject, 2) approve, or 3) approve with a condition or requirement.

To facilitate further handling, vote/score 46 and complete review 48 are preferably input to computer 12 by reviewers 20 using a template or agreed format. Non-reviewing committee members 21 may peruse reviews prepared for the application and the vote tally before submitting their vote. Although the committee members may be known to one another, the reviewers identity and how each member voted is generally not made available to committee members in order to foster impartiality and respect independent judgment. Access to this type of information is controlled by system settings but the data is retained for purposes of the audit trail.

Upon receipt of reviews and votes, the computer updates application database 30 to include the review/score, and preferably also sends a completion notice 50 to chairman/organizer 18 either upon completion of each or upon completion of all of the reviews/scores for a particular application. Review committee chairmen can issue system commands to alter completion notice options. For example, the chairman organizer can use notices after each submission to track status of the review process and/or can use notices after receipt of all submissions as a tickler to generate a consolidated review 52. Consolidated review 52 may or may not take the same form as each individual review 48, but includes the final decision on the application.

Upon completion, chairman/organizer 18 forwards consolidated review 52 to computer 12, which stores the review together with the corresponding application on database 30 for inclusion as part of an audit trail for the review process. Computer 12 also forwards consolidated review 52 or a notice relating thereto to submitter 14.

If the decision is a rejection of the application, the final decision may but need not include reasons for the rejection. Investigator 14 may resubmit his application at 54 as a reply to the consolidated review or with additional supporting data or information. Resubmission 54 is directed by computer 12 for consideration by chairman 18 who may accept, reject or refer the resubmission to review committee 21 in an iterative process according to the guidelines he is bound to follow. Ordinarily, there will be a time or resubmission limit after which an investigator must submit a new application so that applications may be closed and the record of the review archived for audit.

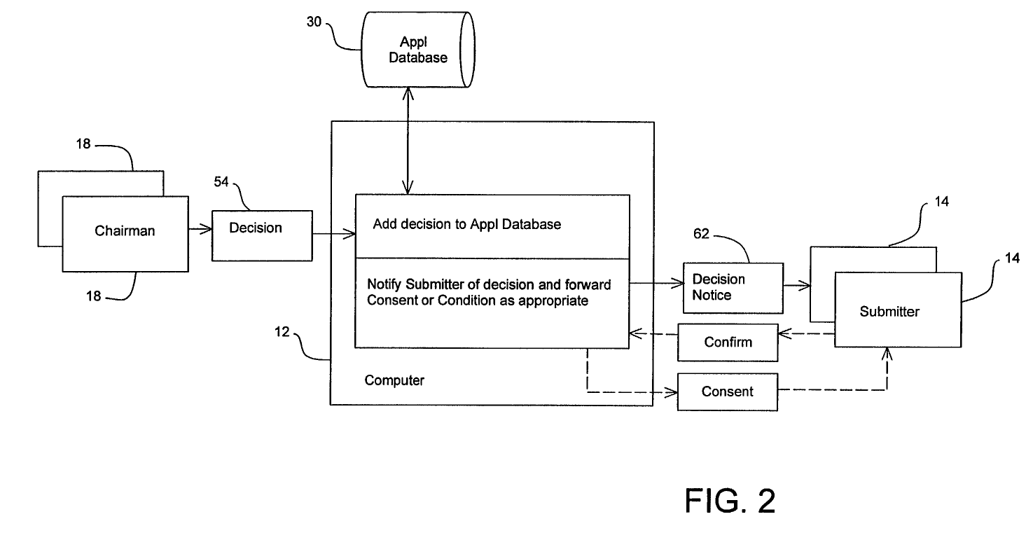

Referring now to FIG. 2, if chairman/organizer 18 decides to approve application 24, then he generates a decision 52 which is input to computer 12. The decision is added to application database 30 together with any conditions or requirements. If decision 52 is an approval and includes no conditions, then computer 12 generates a consent form which is stored on database 30 for the audit trail and is communicated to investigator 14 together with notice of approval 62.

If the decision 52 is a conditional approval, then submitter 14 may obtain a consent form from the chairman by providing a confirmation and/or certification 55 that the required condition(s) has been met (as indicated by dashed lines). The condition and the investigator's confirmation are added to the record of the application's review on database 30. Upon receipt by computer 12, confirmation 55 is forwarded to chairman 18 for consideration. Following consideration, a consent 57 may be prepared and transmitted to the investigator by the computer 12.

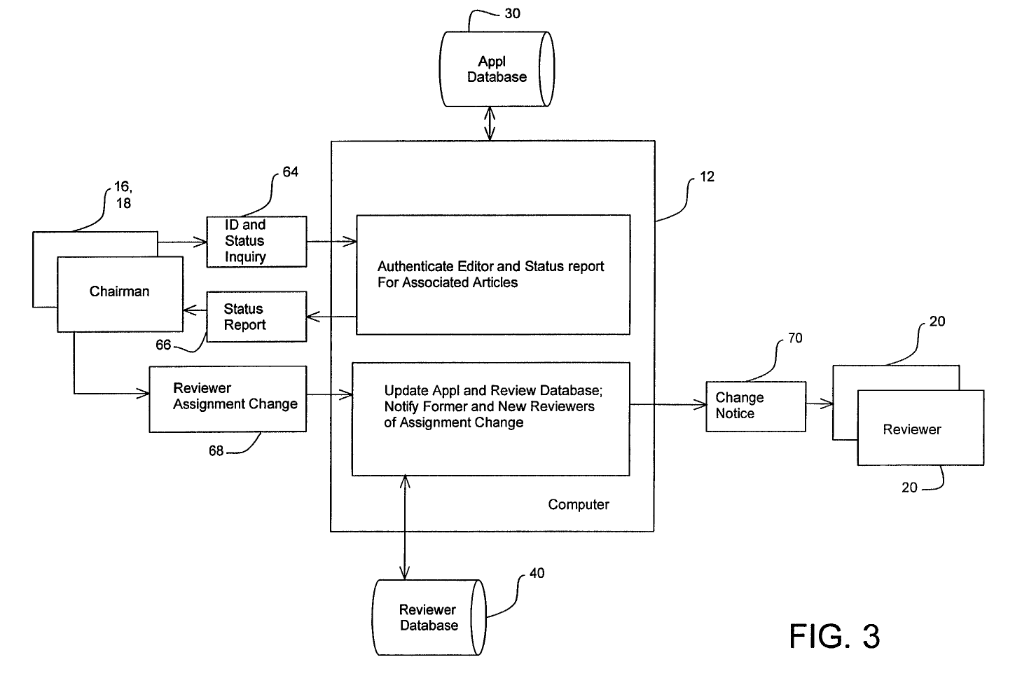

Referring now to FIG. 3, use of system 10 by a chairman 18 to manage the review process is depicted. As indicated at 64, by presenting an identifier (ID) for authentication by computer 12 and an appropriate request, overseer/chairman 16,18 can obtain a status report 66. Status reports provide valuable information for speeding the review process along. The types of data which may be made available include: the reviewers assigned to each application, when the assignment was made, whether the review and/or consolidated review was completed, whether voting is complete, who has not yet voted, the number of applications awaiting review by each reviewer, the number of applications assigned to each chairman, the chairman's specialties, the reviewers' specialties, resubmission statistics and status, condition confirmation status and statistics, and other information useful in tracking and managing the process.

In response to the status report information, chairman 18 can issue a reviewer assignment change 68 as needed or desired to manage the review process. If an assignment change 68 is issued, computer 12 updates application database 30 and reviewer database 40, and notifies the affected reviewers with a change notice 70. It is understood though not specifically illustrated, that an institutional overseer 16 may use the review process of FIG. 3 in a similar manner to change chairmen. Also, any party in the process can send messages to the others and for example comment on the application even if she is not the assigned reviewer.

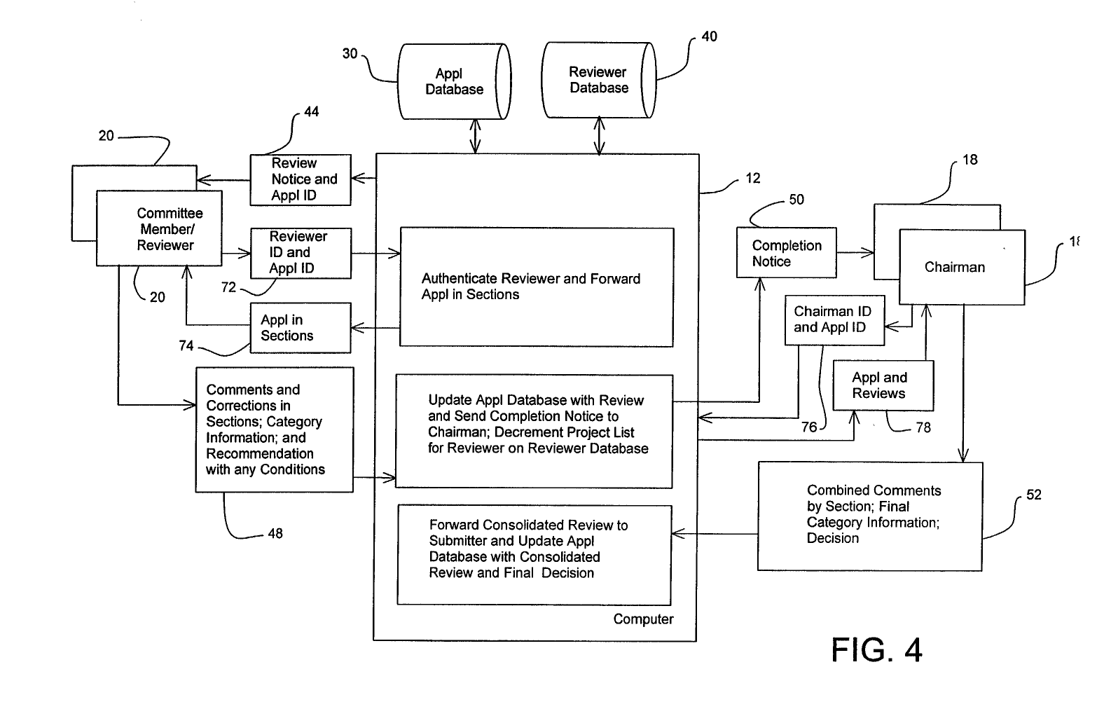

Referring now to FIG. 4, details of the application reviewing process are illustrated. Preferably, computer 12 includes a personal area, most preferably in web space, where committee members 21 including a reviewer 20 can retain their work in progress (WIP). A member's WIP may include a number of different reviews in varying stages of completion for the same or different review committees. The member's personal area may include links to each review in process, the underlying application for each review, dates on which the review was requested and/or is due to be completed. A member's personal space may include status information about a reviewer's review, comments on the application from other members, as well as the vote tally, and the chairman's consolidated review if complete. By retaining this information on a central computer, it can be more or less continuously updated and available for review and continued work by any authorized person from any location until the application is closed and its record of review archived for audit.

As indicated at 44 in FIG. 4, the review notice may include an identifier or link to the application to be reviewed. In the alternative, however, it is understood that the identifier or link may simply be provided for a reviewer in his personal space or computer 12. To obtain access to this personal space or information, a reviewer provides a reviewer identifier 72 which may but need not be simultaneously input to computer 12. Identification 72, which may take the form of a username and password, is used to authenticate the reviewer and determine which applications he is authorized to access on database 30.

If the submitted application identifier, which may take the form of a document or key number, matches an authorized application for an authenticated user, then the application is provided to reviewer 20 preferably in sections (see 74) matching the format of template 26 (see FIG. 1). In addition to the application, reviewer 20 may also obtain access to another review in progress for the application as well as other status information discussed above.

The review 48 made of the application by reviewer 20 is organized with comments and corrections in sections which match those of the application template. Review 48 also includes category information supplied by reviewer 20 as well as a recommendation on approval/rejection of the application. Upon submission to computer 12, review 48 is stored on database 30 together with a corresponding one of applications 24. As described with reference to FIG. 1, completion notice 50 is forwarded to chairman 18 as desired. Also, a project list for the reviewer is decremented on reviewer database 40, so that the reviewer is presumably more likely to obtain additional review assignments.

Chairmen may receive completion notice via electronic message such as email and/or when they connect to computer 12. Similar to reviews 20, chairmen 18 preferably have personal space on computer 12 such that notice 50 may be received upon authentication, whether or not the notice was also received, e.g., by email. When notice 50 indicates that all reviews have been submitted, chairman 18 is informed that it is time to complete her consolidated review. If notices 50 are configured for completion of each review, either computer 12 or chairman 18 may keep track of whether reviews have been submitted by all assigned reviewers. If notices 50 are configured for completion of all reviews and/or votes, then its receipt by chairman 18 is a call to complete the consolidated review.

To prepare consolidated review 52, chairman 18 inputs an identifier at 76, which may take the form of a username and password, for authentication to computer 12. The computer uses the identification to determine which applications among those on database 30 are authorized for access by chairman 18. In this regard, drafts of the consolidated review are stored together with the corresponding application 24 and each of the individual reviews as well as a vote tally.

Chairman 18 may either select the application identifier or link from her personal area or, as indicated on the drawing, submit the application identifier at 76 to computer 12. It is understood that the application identifier may be input together with, before or subsequent to the chairman identifier. Upon request of an authenticated, authorized user, computer 12 permits access by chairman 18 to the application and individual reviews 78, and to drafts of the consolidate review for completion. Consolidated review 52 includes a final decision on the application and may also comprise a combination, on a section-by-section basis, of the comments and conditions included in the individual review(s) as well as those of the chairman. The consolidated review also includes the final category information used for indexing and retrieval of the application. This category information preferably includes indicators as to a subject of the procedure as well as an indicator of the guidelines followed for the review and the source of funding for purposes of retrieval by an auditor or collaborator. If the decision is to approve the application, then a consent form is included together with the decision.

Referring now to FIG. 5, depending upon access permissions set by the system administrator, information about applications and their associated reviews is available to be searched and retrieved by third party users. The extent of access will depend upon the party's purpose so that for example an auditor may have full access, while a potential patient seeking treatment options may have very restricted access such as statistical information on applications, with a committee members access level lying somewhere in between. These access policies may be set and modified by institutional overseer 16 or another authenticated system administrator by issuing appropriate system commands to computer 12.

A third party user 22 may register online directly with computer 12 by agreeing to a user policy and providing basic information. A registration template 80, which may but need not include a user policy, is forwarded to a casual user by computer 12 upon request. Upon supplying the required data, user 22 submits registration 82 for processing. If the registration request is in order, an access level is assigned to the user and a profile is created together with a user identifier 84, which may take the form of a user name and password, for purposes of authentication to computer 12.

Upon authentication of a user 22 by computer 12 with user identifier 84, computer 12 presents the authenticated user with his personal profile 86. Profile 86 includes personal space on a user database 90 for storing search logic, search results, retrieved articles, excerpts of retrieved articles, drafts of applications or comments on applications for submission to system 10, and other work product. Profile 86 may also provide email, and other services.

An authenticated user may issue commands 92 to computer 12 in order to create and organize folders, save, edit and create applications and the like. In addition to commands relating to profile 86, an authenticated user may also issue search and retrieval commands depending upon their assigned access level. In this manner an auditor may observe the review process in action in order to verify compliance. Similarly, collaborators in the application, such as instrument manufacturer's and researchers may monitor the status of applications relating to their work.

While the invention has been described with reference to a particular arrangement of parts, features and the like, these are not intended to exhaust all possible arrangements or features, and indeed many other modifications and variations will be ascertainable to those of skill in the art.

What is claimed:

1. A medical or veterinary procedure review system, comprising:
an application to perform a nonstandard procedure on a patient;
a computer for receiving said application;
a program executing on said computer to cause said application to be forwarded to a reviewer; and
a review of said application submitted to said computer for storage together with said application;
said program generating a record of the review process for consideration by a third party.

2. The review system of claim 1 wherein the third party is an auditor of the procedure review system.

3. The review system of claim 1 wherein the third party is an IRB committee member.

4. The review system of claim 1 wherein the third party is an IACUC committee member.

5. The review system of claim 1 wherein the third party is a collaborator in the procedure.

6. The review system of claim 5 wherein the third party is a manufacturer of equipment used to perform the procedure.

7. The review system of claim 1 including an application database accessible to said computer for storing data, and wherein said program assigns an identifier to said application and stores said application and application identifier on said database.

8. The review system of claim 7 wherein said application database includes an investigator identifier stored together with the corresponding application and application identifier.

9. The review system of claim 1 wherein said application includes all information necessary for said computer to generate a consent.

10. The review system of claim 1 wherein the third party submits to said computer a vote on whether to approve or reject the application.

11. The review system of claim 10 wherein numerous votes are submitted and wherein the third party can see a tally of the votes but not an identity of the votes.

12. The review system of claim 1 wherein the identity of the reviewer is not known to the third party.

13. The review system of claim 1 wherein upon completion of voting, a decision is forwarded to an investigator who submitted said application.

14. The review system of claim 13 wherein a consent form is forwarded to the investigator together with the decision.

15. The review system of claim 13 wherein the decision is conditional.

16. The review system of claim 15 wherein upon submission by the investigator of a certification that the condition is met, a consent form is generated.

17. A medical or veterinary procedure review auditing system comprising:
a database of applications too perform nonstandard procedures;
a computer connected to the Internet and configured for storing and retrieving data on said database;
electronic access to said computer by reviewers for generating reviews of the applications;
electronic access to said computer by review committee members to electronically vote on the applications;
software executing on said computer for storing the reviews and the votes on said database together with a corresponding one of the applications; and
electronic access to said computer by an auditor to audit compliance of the application review and voting process with guidelines by retrieving the application and associated documents and records from said database.
